(19) United States
(12) Patent Application Publication
(10) Pub. No.: US 2004/0263676 A1
(43) Pub. Date: Dec. 30, 2004

(54) System and method for determining the operational status of an imaging system including an illumination modulator

(76) Inventors: Bryan Comeau, Atkinson, NH (US); Philip Rombult, Boxford, MA (US); David Romano, Sandown, NH (US)

Correspondence Address: Agfa Corporation, Law & Patent Department, 200 Ballardvale Street, Wilmington, MA, 01887-1069, US

(21) Appl. No.: 10/609,303

(22) Filed: Jun. 27, 2003

(51) Int. Cl. H04N 5/222

(52) U.S. Cl. 348/370

(57) ABSTRACT

A system is disclosed for determining whether an imaging system is in a proper operating condition. In an embodiment, the system includes an illumination modulator for providing a desired modulated illumination field at an image surface, a detection unit including a slit opening for receiving a portion of the modulated illumination field, an average power sample unit and a variation power sample unit. The average power sample unit is for determining the average power sample value of the modulated illumination field as the modulated illumination field is moved with respect to the slit opening and for determining whether the average power sample value has changed significantly since a previous scan. The variation power sample unit is for determining the variation in power sample values of the modulated illumination field as the modulated illumination field is moved with respect to the slit opening and for determining whether the variation in power sample values has changed significantly since a previous scan.

### BACKGROUND

The invention generally relates to imaging systems, and relates in particular to imaging systems that include a spatial light modulator.

It is known that imaging systems, like many systems that involve the use of illumination, require some period of time to warm up before the system is used in operation. This period of time should be sufficient to permit the components of the system to reach their respective operational temperatures.

Conventionally, one or more of the components may include a temperature sensor or a timing circuit that requires that the system not be used until either the temperature is reached or the time delay has expired. Time out delays, however, may not take into account instances where the power had recently been turned off, and temperature sensors may only be positioned at certain locations, which may or may not actually have a bearing on image quality.

It is desirable to more precisely determine the point in time at which an imaging system is ready to begin imaging. This would permit users to make maximum use of such systems by not losing time waiting for unnecessary warm up periods.

### SUMMARY

The invention provides a system for determining whether an imaging system is in a proper operating condition. In an embodiment, the system includes an illumination modulator for providing a desired modulated illumination field at an image surface, a detection unit including a slit opening for receiving a portion of the modulated illumination field, an average power sample unit and a variation power sample unit. The average power sample unit is for determining the average power sample value of the modulated illumination field as the modulated illumination field is moved with respect to the slit opening and for determining whether the average power sample value has changed significantly since a previous scan. The variation power sample unit is for determining the variation in power sample values of the modulated illumination field as the modulated illumination field is moved with respect to the slit opening and for determining whether the variation in power sample values has changed significantly since a previous scan.

### BRIEF DESCRIPTION OF THE ILLUSTRATED EMBODIMENTS

The following description may be further understood with reference to the accompanying drawings in which:

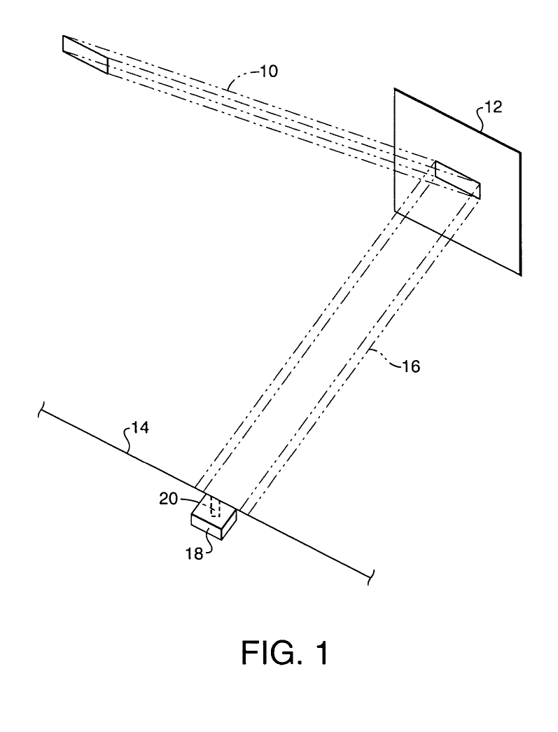

FIG. 1 shows an illustrative diagrammatic view of an imaging system employing a detection unit in accordance with an embodiment of the invention;

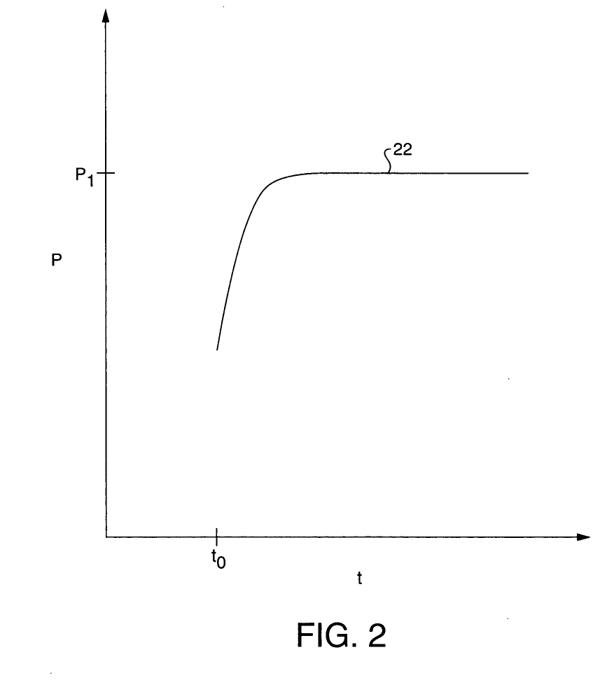

FIG. 2 shows an illustrative graphical representation of the power versus time relationship of an imaging system of the invention;

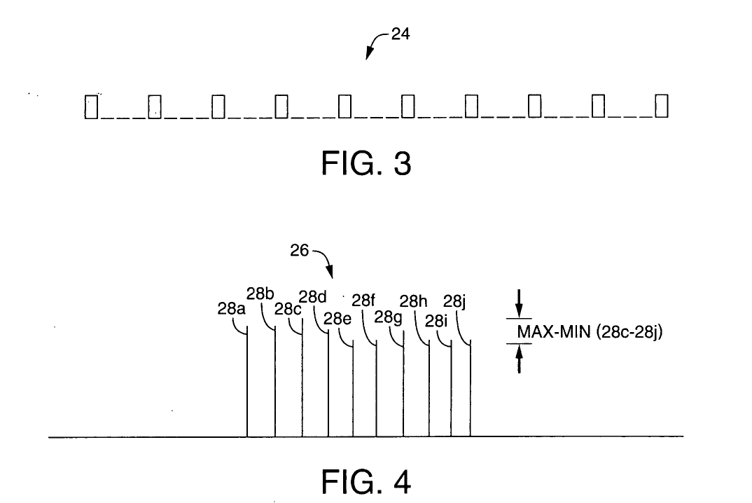

FIG. 3 shows an illustrative diagrammatic view of a modulator test pattern in accordance with an embodiment of the invention;

FIG. 4 shows an illustrative diagrammatic view of samples taken from a single shutter of FIG. 3 in accordance with an embodiment of the invention; and

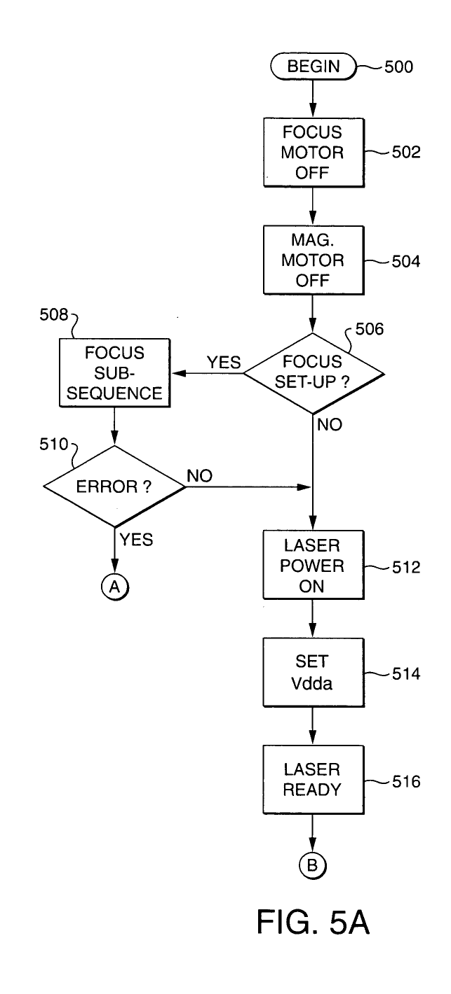

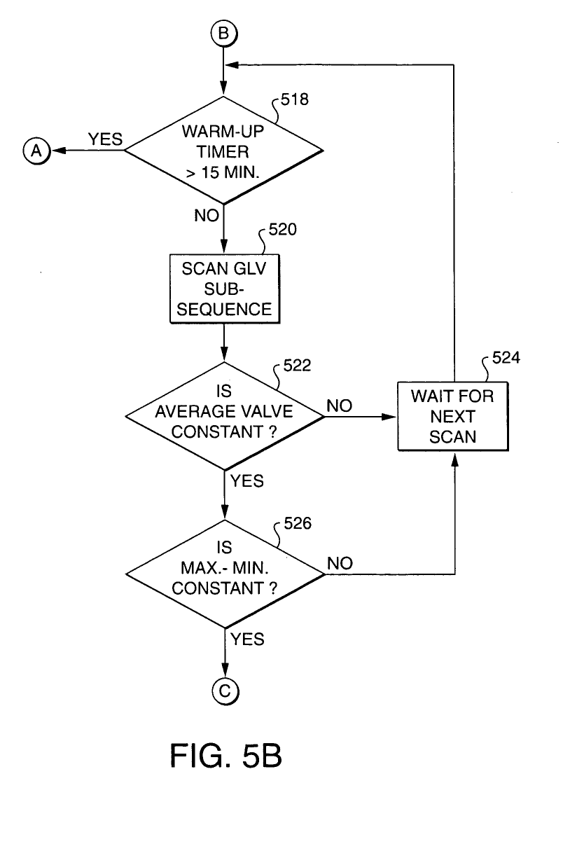

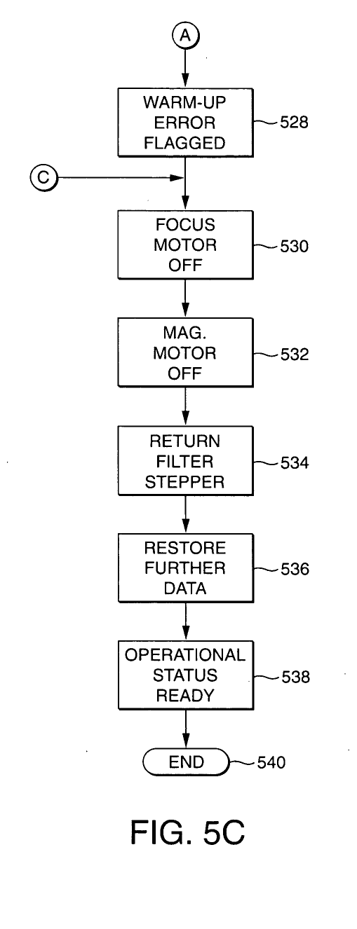

FIGS. 5A-5C show illustrative diagrammatic views of a process in accordance with an embodiment of the invention.

The drawings are shown for illustrative purposes only and are not to scale.

### DETAILED DESCRIPTION OF THE ILLUSTRATED EMBODIMENTS

As shown in FIG. 1, an imaging system in accordance with an embodiment of the invention includes an illumination source producing an illumination field 10 (which may be in the form of a line of laser illumination as disclosed, for example, in U.S. Pat. No. 6,433,934, the disclosure of which is hereby incorporated by reference), an illumination modulator 12, and an imaging surface 14. The illumination modulator may, for example, include a grating light valve (GLV) as sold by Silicon Light Machines of Sunneyvale, Calif., and the imaging plane 14 may include an imagable medium on a rotatable drum. The illumination field 10 is directed toward the modulator 12 via a field lens system (not shown) including one or more lenses, and the modulated illumination field 16 is directed toward the imaging surface 14 via imaging optics (not shown) as is well known in the art. In particular, the modulator 12 may, for example, direct the illumination field 16 toward the imaging surface 14 along the zero order reflection path when the modulator is not activated, and may direct the illumination field 10 along ± first order reflection paths (missing the imaging surface) when the modulator is activated.

The system further includes a detection unit 18 that is located in the plane of the imaging surface 14 adjacent the imagable medium. The detection unit 18 includes a slit opening 20 (of, for example 10 microns) that permits a small portion only of the illumination field 16 to enter the unit 18 as the unit is moved in the slow scan direction (along the longitudinal length of the surface 14).

As shown at 22 in FIG. 2, when the system is turned on during use (t₀), the power begins to rise, but requires a certain amount of time to reach a stable level (P₁) from which is subsequently undergoes little change. Time is shown along the horizontal axis in FIG. 2 and power is shown along the vertical axis.

In accordance with an embodiment of the invention a test pattern is provided in the light modulator 12 having a one on and three off arrangement as shown at 24 in FIG. 3. For example, with a GLV, every fourth shutter may be actuated to provide this test pattern. As shown at 26 in FIG. 4, ten samples (28a-28j) may be taken for each shutter as the illumination field 16 is moved in the slow scan direction across the slit 20.

In accordance with an embodiment, the system may record each of the samples for each of the shutters across the entire illumination field 16 from the GLV 12 for a scan set, e.g., five scans. The system may then record the average value for that scan set. The scans are then repeated and the average value for a subsequent scan set is again determined and compared with the average value for the prior scan set. When the average value for a subsequent scan set varies from the average value from a prior scan set by less than a predetermined threshold, e.g., 0.75%, then the average power is determined to be constant.

The system then determines with the variation from minimum to maximum within a scan is sufficiently constant. This is determined by again sampling the illumination field 16 with the one on and three off pattern as above and recording the minimum sample value and the maximum sample value for each shutter and for the entire scan. The difference between the maximum sample value and minimum sample value for each scan is recorded and compared with the difference between the maximum sample value and minimum sample value for the previous scan. When the difference for a subsequent scan varies from the difference from a prior scan by less than a predetermined threshold, e.g., 0.25%, then the variations in power are determined to be constant.

In particular, a process of detecting the proper warm-up condition of an illumination system of the invention is described below with reference to FIGS. 5A-5C. The process begins (step 500) by confirming that the focusing position motor has not moved (step 502), and that the magnification stepper motor has not moved (step 504). The method then determines whether focusing set-up is required (step 506), and if so, the process initializes a focusing subsequence (step 508). If an error is detected (step 510), then the system moves to step 528 as shown in FIG. 5C and discussed below. If an error is not detected (step 510), then the process turns the laser power on (step 512), sets the voltage on the modulator 12 (step 514) and then determines that the laser is in ready condition (step 516).

The process then determines whether a timeout timer has expired (set for example, to 15 minutes). If so, the process proceeds to step 528 (discussed below) as shown in FIG. 5C. If the timeout timer has not yet expired, the process scans a GLV sub-sequence and records the samples for all of the shutters across the GLV (step 520). The process then determines whether the average sample value has stopped changing significantly from the previous scan (step 522), and if no the process waits for the next scan (step 524) and returns to step 518 above. If the average sample value has stopped changing, the process then determines whether the maximum-minimum sample values for a scan have stopped changing significantly from the previous scan (step 526). If not, the process proceeds to step 524 as discussed above, and if so then the process proceeds to step 530 in FIG. 5C.

As shown in FIG. 5C, in step 528 the process sets an error condition indicating that an error has occurred. The process then turns the focusing motor off (step 530), turns the magnification motor off (step 532), returns the filter stepper to its original position (step 534) and restores further data to the pre-process conditions (step 536). The operational status of the system is then indicated as ready (step 538) and the process then ends (step 540). In certain embodiments, the process may then return to step 500.

Those skilled in the art will appreciate that numerous modifications and variations may be made to the above disclosed embodiments without departing from the spirit and scope of the invention.

What is now claimed is:

1. A system for determining whether an imaging system is in a proper operating condition, said system comprising:
an illumination modulator for providing a desired modulated illumination field at an image surface;
a detection unit including a slit opening for receiving a portion of said modulated illumination field;
average power sample means for determining the average power sample value of said modulated illumination field as said modulated illumination field is moved with respect to said slit opening and for determining whether said average power sample value has changed significantly since a previous scan; and
variation power sample means for determining the variation in power sample values of said modulated illumination field as said modulated illumination field is moved with respect to said slit opening and for determining whether said variation in power sample values has changed significantly since a previous scan.

2. A system as claimed in claim 1, wherein said illumination modulator includes a grating light valve.

3. A system as claimed in claim 1, wherein said average power sample means includes an average power sample value for a prior scan.

4. A system as claimed in claim 1, wherein said variation power sample means includes information indicative of a variation in power sample values for a prior scan.

5. A system as claimed in claim 1, wherein said variation power sample means includes maximum and minimum sample values for a previous scan.

6. A system as claimed in claim 1, wherein said variation power sample means includes maximum and minimum sample values for a grating light valve shutter.

7. A system for determining whether an imaging system is in a proper operating condition, said system comprising:
an illumination modulator for providing a desired modulated illumination field at an image surface;
a detection unit including a slit opening for receiving a portion of said modulated illumination field;
average power sample means for determining the average power sample value of a set of scans of said modulated illumination field as said modulated illumination field is moved with respect to said slit opening and for determining whether said average power sample value has changed significantly since a previous set of scans; and
variation power sample means for determining the variation in power sample values of a set of scans of said modulated illumination field as said modulated illumination field is moved with respect to said slit opening and for determining whether said variation in power sample values has changed significantly since a previous set of scans.

8. A system as claimed in claim 7, wherein said illumination modulator includes a grating light valve.

9. A system as claimed in claim 7, wherein said average power sample means includes an average power sample value for a prior set of scans.

10. A system as claimed in claim 7, wherein said variation power sample means includes information indicative of a variation in power sample values for a prior set of scans.

11. A system as claimed in claim 7, wherein said variation power sample means includes maximum and minimum sample values for a previous scan.

12. A system as claimed in claim 7, wherein said variation power sample means includes maximum and minimum sample values for a grating light valve shutter.

13. A system as claimed in claim 7, wherein said average power sample value of a set of scans is determined for a set of five scans.

14. A system as claimed in claim 7, wherein said variation in power sample values of a set of scans is determined for a set of five scans.
